(19) United States
(12) Patent Application Publication
(10) Pub. No.: US 2004/0172844 A1
(43) Pub. Date: Sep. 9, 2004

(54) Pattern hole-transfer template, and hole patterning method

(76) Inventors: Janis L. Murray, Peoria, AZ (US); Richard T. Murray, Peoria, AZ (US)

Correspondence Address: Sullivan Law Group, Suite 1140, 1850 North Central Avenue, Phoenix, AZ, 85004-4586, US

(21) Appl. No.: 10/384,079

(22) Filed: Mar. 7, 2003

(51) Int. Cl. G01B 3/14

(52) U.S. Cl. 33/563

(57) ABSTRACT

A method is provided for forming a pattern of holes in a medium. According to an embodiment of the method, a pattern hole-transfer template is provided. The template has a first surface and a second surface opposite and facing away from one another, and a plurality of discrete circular apertures spaced apart from one another and extending through the template from the first surface to the second surface. The template is mounted on a medium. Then, a tool is inserted through the discrete circular apertures of the template and penetrated through the medium to form a pattern of holes in the medium. The template is separated from the medium.

### BACKGROUND OF THE INVENTION

1. Field of the Invention

The present invention relates to pattern hole-transfer templates and methods for their use, especially in the paper crafting art.

2. Description of the Related Art

Paper crafting is an art form shared and enjoyed by novices, hobbyists and professionals alike. Paper crafting involves many different facets, including but not limited to scrap-booking, card-making (such as greeting cards), paper embellishing, bookbinding, book altering, and designing in the areas of collage art and tag art. The paper crafting industry has seen giant growth strides over the past few years. Scrap-booking alone has been estimated as a $2 billion a year industry. Paper crafting products have become widespread staple items at art supply stores. Web sites can be found on the internet covering a wide multitude of paper crafting tools, techniques, and projects.

One aspect of paper crafting involves the formation of a pattern of holes within a paper product. Various reasons exist for forming holes in paper products. For example, holes themselves may enhance the aesthetics of a paper craft. Holes may also be used for mounting functional or decorative items, such as grommets or brads. Additionally, holes formed within the paper product may serve as a guide for stitching thread or other objects through the paper product.

The aesthetic appearance or functional efficacy of holes formed in a paper product often depends on preciseness of hole location and uniformity in hole size. The successfulness of a project often turns on whether holes are precisely aligned and spaced with each other and with the border of the paper product. In the past, artists have often had to estimate the appropriate location of holes to be formed by “eye-balling” the project. More meticulous artists often use rulers to mark the spot on the paper product at which to form the hole. This latter technique requires not only that the spot be precisely marked, but also that the punching device precisely overlaps the marked spot. Slight placement error in either of these steps can vitiate the uniformity and alignment of the holes. Another factor that must be taken into consideration is the diameter of the hole formed by the punching tool. Punching tools usually are tapered, so as to have a variable cross-sectional thickness that constricts until terminating at a pointed end of the tool. Due to the tapering cross section of the tool, the diameter of the hole formed by the tapered tool will be dependent upon the extent of the tool length passed through the medium. To ensure uniformity in hole diameter from hole-to-hole, the variable thickness punching tool must consistently penetrate a constant depth through the paper product.

### OBJECTS OF THE INVENTION

Accordingly, an object of the present invention is to provide a template that allows its user to form a uniform and precisely located pattern of holes in a medium.

It is another object of the present invention to provide a method for forming holes with uniformity and precision in a medium.

Additional objects and advantages of the invention will be set forth in the description which follows, and in part will be apparent from the description, or may be learned by practice of the invention. The objects and advantages of the invention may be realized and obtained by means of the instrumentalities and combinations pointed out in the appended claims.

### SUMMARY OF THE INVENTION

To achieve the foregoing objects, and in accordance with the purposes of the invention as embodied and broadly described in this document, a method of a first aspect of the invention is provided for forming a pattern of holes in a medium. The method comprises providing a pattern hole-transfer template comprising a substantially flat sheet having a first surface and a second surface opposite and facing away from one another. The substantially flat sheet comprises a plurality of discrete circular apertures spaced from one another and extending through the substantially flat sheet from the first surface to the second surface. The pattern hole-transfer template is mounted on a medium. A tool is inserted through the discrete circular apertures of the pattern hole-transfer template and penetrated through the medium to form a pattern of holes in the medium. The pattern hole-transfer template is then separated from the medium.

To achieve additional objects, and in accordance with the purposes of the invention as embodied and broadly described in this document, a method of a second aspect of the invention is provided for forming a pattern of stitch holes in a medium. The method of this aspect of the invention comprises providing a stitch pattern hole-transfer template comprising a substantially flat sheet having a first surface and a second surface opposite and facing away from one another. The substantially flat sheet comprises a plurality of discrete circular apertures spaced apart from one another and extending through the substantially flat sheet from the first surface to the second surface. The stitch pattern hole-transfer template is mounted on a medium, and a tool is inserted though the discrete circular apertures of the stitch pattern hole-transfer template and penetrated through the medium to form a pattern of stitch holes in the medium. The stitch pattern hole-transfer template is separated from the medium, and thread is stitched through the stitch holes to form a stitch pattern.

In a presently preferred embodiment of the first and second aspects of the invention, the substantially flat sheet is translucent. In another preferred embodiment, the substantially flat sheet has a continuous outer edge defining a parallelogram.

According to another preferred embodiment of the first and second aspects of the invention, the apertures each have identical diameters to one another.

In yet another preferred embodiment of the first and second aspects of the invention, a first set of the apertures comprises first apertures arranged along a first linear pattern, and a second set of the apertures comprises second apertures arranged along a second linear pattern. Adjacent ones of the first apertures are spaced apart from one another by a first uniform distance, and adjacent ones of the second apertures spaced apart from one another by a second uniform distance differing from the first uniform distance. Preferably, the first and second linear patterns are parallel to and spaced apart from one another.

In still another preferred embodiment of the first and second aspects of the invention, the substantially flat sheet further comprises markings on the first surface for aligning the template relative to opposite edges of the medium. Preferably, the pattern comprises a straight aperture line including at least three of the apertures, and the markings comprise first and second marking lines arranged transverse to the straight aperture line. The first and second marking lines are preferably symmetrical to one another and equidistant from a center of the substantially flat sheet. The first and second marking lines may be spaced apart from one another by a distance of, for example, 4.25 inches, 5.5 inches, 6.25 inches, 8.5 inches, and/or 11 inches.

The substantially flat sheet may comprise a straight marking line arranged transverse to the straight aperture line and centrally located on the substantially flat sheet so as to be equidistant from opposite edges of the substantially flat sheet.

According to another preferred embodiment of the first and second aspects of the invention, the apertures comprise a first set of the apertures arranged along a first linear pattern and a second set of the apertures arranged along a second linear pattern transverse to the first linear pattern. The first and second linear patterns each respectively comprises at least three of the apertures, with at least one of the apertures of the first and second linear patterns being mutually shared by the first and second linear patterns.

The mounting step of the first and second aspects of the invention preferably comprises abutting the medium against a member selected from the group consisting of the first surface and the second surface of the substantially flat sheet. The medium may comprise a product formed from cellulosic pulp, such as paper or a paper-product. Other media that may be used in accordance with this invention include fabric decorative foils, clay, ceramics, wood, wood veneer, and the like.

Representative insertion tools that may be used in connection with the first and second aspects of the invention include awls, pins, needles, hole punches, and the like.

The resulting pattern formed in the medium as the result of penetrating the tool through the medium may take various random or non-random shapes or patterns. For example, the pattern may form an outline of a tangible object, such as an animal, plant, geometric shape, star, etc.

The method of first and second aspects of the invention may be practiced to make borders, photo mattes, accents, pocket pages, cards, and the like. Another application of the methods of this invention comprises binding the pages of handmade books and booklets.

In an especially preferred embodiment of the first and second aspect of the invention, the method further comprising placing and aligning grommets over respective holes in the medium. The holes preferably have apertures matching the size of the central holes of the grommets, and more preferably but optionally have diameters of at least 0.1875 inch (0.47625 cm).

### BRIEF DESCRIPTION OF THE DRAWINGS

The accompanying drawings, which are incorporated in and constitute a part of the specification, illustrate a presently preferred embodiments and methods of the invention and, together with the general description given above and the detailed description of the preferred embodiments and methods given below, serve to explain the principles of the invention. In such drawings:

FIG. 1. is a plan view of a pattern hole-transfer template in accordance with a first embodiment of the invention;

FIG. 2 is a plan view of a pattern hole-transfer template in accordance with a second embodiment of the invention;

FIG. 3 is a plan view of a pattern hole-transfer template in accordance with a third embodiment of the invention; and

FIG. 4 is a plan view of a pattern hole-transfer template in accordance with a fourth embodiment of the invention.

### DETAILED DESCRIPTION OF THE PREFERRED EMBODIMENTS AND METHODS

Reference will now be made in detail to the presently preferred embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the preferred embodiments and methods. The invention according to its various aspects is particularly pointed out and distinctly claimed in the attached claims read in view of this specification, and appropriate equivalents.

It is to be noted that, as used in the specification and the appended claims, the singular forms “a,” “an,” and “the” include plural referents unless the context clearly dictates otherwise.

In accordance with preferred aspects of the invention, a pattern hole-transfer template is provided which comprises a substantially flat sheet having a first surface and a second surface opposite and facing away from one another. The substantially flat sheet comprises a plurality of discrete circular apertures spaced from one another and extending through the substantially flat sheet from the first surface to the second surface.

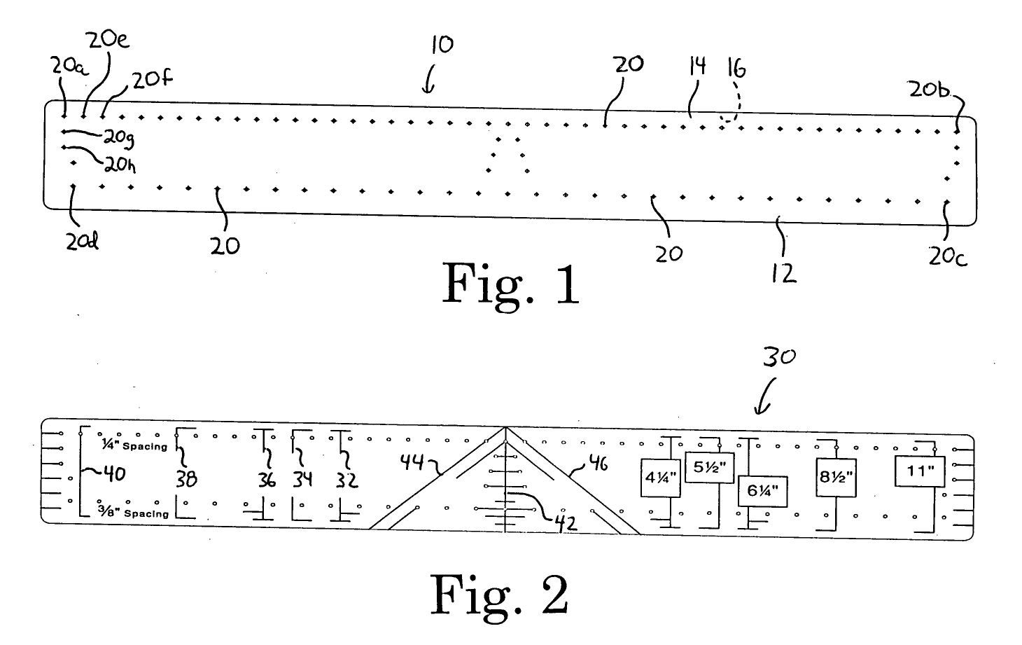

A pattern hole-transfer template according to a first presently preferred embodiment is shown in FIG. 1 and generally designated by reference numeral 10. The pattern hole-transfer template 10 comprises a substantially flat sheet 12 having a first surface 14 and a second surface 16. The first surface 14 and the second surface 16 are opposite to and face away from one another. As shown in FIG. 1, the pattern hole-transfer template 10 may optionally have a continuous outer edge 22 or perimeter that defines a parallelogram, such as a rectangle. In one preferred embodiment, the template 20 is 12 inches (30.48 cm) long and 1.75 (4.445 cm) inches wide. Although not shown, the outer edge 22 may take on other geometric or random shapes, may be non-continuous, and/or may contain nonlinear, e.g., curved, sections.

The pattern hole-transfer template 10 is preferably made of a material that is sufficiently translucent to permit the user to view an object or medium situated on an opposite side of the template 10. Preferred materials include flexible and rigid plastics, such as polyvinylchloride. It is also possible to use other translucent materials, as well as non-translucent materials, such as metal, alloys, wood, plastic, etc., that are compatible with the objects of this invention.

Discrete circular apertures 20 extend through the substantially flat sheet 12 from the first surface 14 to the second surface 16. The discrete circular apertures 20 may be formed, for example, by routing or drilling.

As shown in FIG. 1, the apertures 20 are spaced apart from one another to define patterns. A first set of the apertures 20 extending between apertures 20a and 20b define a first linear pattern. The first set of apertures preferably includes at least three apertures, more preferably at least five apertures. As shown in FIG. 1, the template 10 has 47 apertures in its first set. The apertures 20 of the first linear pattern are shown uniformly spaced from the outer edge 22 of the template 10 to define a border of constant width. Preferably, each of the apertures 20 of the first linear pattern has an identical diameter. Also preferably, adjacent apertures 20 of the first linear pattern are spaced apart from one another by a first uniform distance. In a currently preferred but optional embodiment, the first uniform distance is 0.25 inch (0.635 cm). A second set of apertures 20 extending between apertures 20c and 20d define a second linear pattern. The second set of apertures preferably includes at least three apertures, more preferably at least five apertures. The second set of apertures shown in FIG. 1 has 31 apertures. The apertures 20 of the second linear pattern are shown uniformly spaced from the outer edge 22 of the template 10 to define a border of constant width. Preferably, each of the apertures 20 of the second linear pattern has an identical diameter. Also preferably, adjacent apertures 20 of the second linear pattern are spaced apart from one another by a second uniform distance. In a currently preferred yet optional embodiment, the second uniform distance is 0.375 inch (0.9525 cm). In the illustrated embodiment of FIG. 1, the first and second linear patterns are parallel to one another. Also in the illustrated embodiment, the diameters of the apertures are all identical, and more specifically are 0.050 inch (0.127 cm) in a currently preferred yet optional embodiment.

Additional patterns defined by the embodiment of FIG. 1 will be discussed in further detail with reference apertures 20e, 20f, 20g, and 20h. The first set of apertures 20 includes at least three apertures 20a, 20e, and 20f arranged along the first linear pattern. A third set of apertures 20 includes at least three apertures 20a, 20g, and 20h arranged along a third linear pattern. The first and third linear patterns are transverse (or orthogonal) to one another. Aperture 20a is common to (or shared by) the first and third linear patterns, and constitutes a corner aperture mutually shared by the first and third linear patterns.

The pattern hole-transfer template 10 of the first illustrated embodiment further comprises apertures 20i, 20j, 20k, 201, 20m, and 20n patterned as symmetrical diagonal lines. Each diagonal line may be extrapolated to intersect apertures of the first linear pattern and the second linear pattern.

FIG. 2 depicts another embodiment of a pattern hole-transfer template 30. The pattern hole-transfer template 30 of FIG. 2 shares many of the features, patterns, and characteristics of the template 10 of FIG. 1. Accordingly, like features will be designated by identical reference numerals in FIGS. 1 and 2. Further, in the interest of brevity, the like features, patterns, and characteristics are incorporated with regard to the description of FIG. 2, but are not expressly repeated hereinbelow.

The pattern hole-transfer template 30 of FIG. 2 comprises linear markings for aligning the template relative to opposite edges of a medium in which a pattern of holes will be formed. The linear markings may be present on the first surface 14, the second surface 16, or the first and second surfaces 14 and 16.

As shown in FIG. 2, the linear markings may comprise first and second marking lines arranged transverse to the first and second linear patterns and spaced apart from one another by a predetermined distance. As illustrated in FIG. 2., the first and second marking lines may be symmetrical to one another and equidistant from a center of the substantially flat sheet. The template 30 of FIG. 2 includes marking lines pairs 32, 34, 36, 38, and 40, which are spaced apart from one another by 4.25 inches (10.795 cm), 5.5 inches (13.97 cm), 6.25 inches (15.875 cm), 8.5 inches (21.59 cm), and 11 inches (27.94 cm), respectively. The numeric distances between the marking line pairs are preferably printed on the first or second surface 14 or 16 in inches or other measuring (e.g., SI) units. Also in the illustrated embodiment, transverse lines are respectively located at (and optionally intersect) the ends of the marking lines to form a right angle with the marking lines.

Also shown in FIG. 2 is a central marking line 42 arranged transverse to the straight aperture lines and centrally located on the substantially flat sheet 12 so as to be equidistant to opposite edges of the substantially flat sheet. Extending symmetrically at 45 degree angles from opposite sides of the central marking line 42 are diagonal marking lines 44 and 46. The diagonal marking lines 44 and 46 intersect one another at the outer edge 22 of the substantially flat sheet 12. Preferred uses of the diagonal marking lines 44 and 46 are described below.

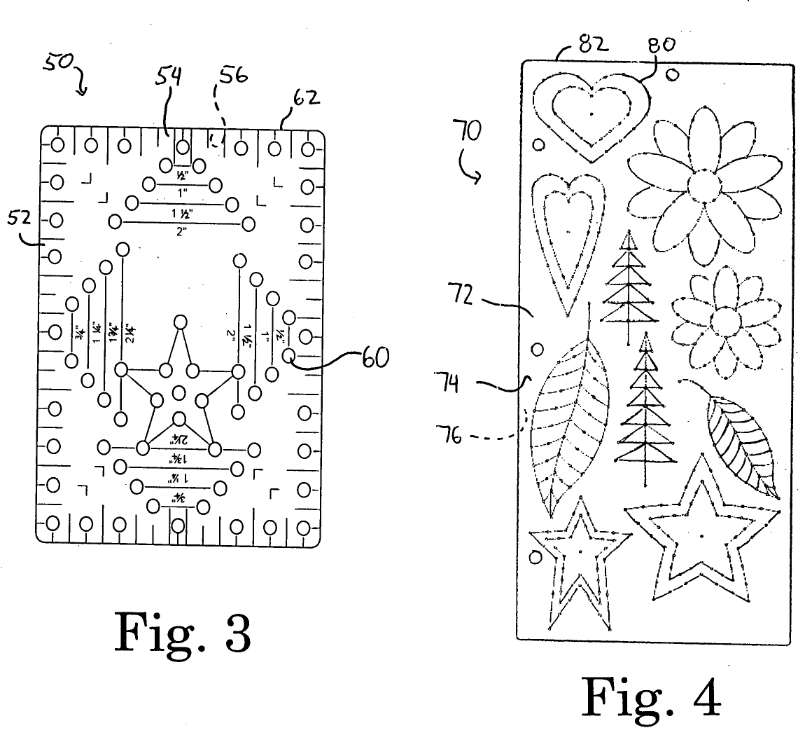

A pattern hole-transfer template according to a third presently preferred embodiment is shown in FIG. 3 and generally designated by reference numeral 50. The pattern hole-transfer template 50 comprises a substantially flat sheet 52 having a first surface 54 and a second surface 56. The first surface 54 and second surface 56 are opposite to and face away from one another. As shown in FIG. 3, the pattern hole-transfer template 50 may optionally have a continuous outer edge 62 or perimeter that defines a parallelogram, such as a rectangle. In one preferred embodiment, the template 50 is 5.5 inches (13.97 cm) long and 4.25 (10.795 cm) inches wide. Although not shown, the outer edge 62 may take on other geometric or random shapes, may be non-continuous, and/or may contain nonlinear, e.g., curved, sections.

The pattern hole-transfer template 50 is preferably made of a material that is sufficiently translucent to permit the user to view an object or medium situated on an opposite side of the template 50. Preferred materials include flexible and rigid plastics, such as polyvinylchloride. It is also possible to use other translucent materials, as well as non-translucent materials, such as metal, alloys, wood, plastic, etc., that are compatible with the objects of this invention.

Discrete circular apertures 60 extend through the substantially flat sheet 52 from the first surface 54 to the second surface 56. As shown in FIG. 3, the apertures 60 are spaced from one another to define discernible patterns. The template 50 depicts straight lines, intersecting lines, and an outline of a star.

As illustrated in the third embodiment, the discrete circular apertures 60 may have enlarged diameters, such as, for example, 0.1875 inch (0.47625 cm). The significance of the enlarged diameters is discussed in further detail below.

The pattern hole-transfer template 50 further comprises linear markings for aligning the template relative to opposite edges of a medium in which a pattern of holes is to be formed. The linear markings may be present on the first surface 54, the second surface 56, or the first and second surfaces 54 and 56. These markings include, for example, lines extending inward from the outer edge 52 of the template 50, such as represented by reference numeral 62. Additionally, linear markings, such as designated by reference numeral 64, extend between a pair of apertures 60. The numeric distance between the pair of apertures 64 may be recorded on the template 50 in suitable units, such as inches or SI units, for example. By way of example, the illustrated embodiment identifies distances in inches, e.g., ¾″, 1¼″, 1¾″, 2¼″, ½″, 1″, 1½″, and 2″.

A fourth presently preferred embodiment of a pattern hole-transfer template of the invention is shown in FIG. 4 and generally designated by reference numeral 70. The pattern hole-transfer template 70 comprises a substantially flat sheet 72 having a first surface 74 and a second surface 76. The first surface 74 and second surface 76 are opposite to and face away from one another. As shown in FIG. 4, the pattern hole-transfer template 70 may optionally have a continuous outer edge 82 or perimeter that defines a parallelogram, such as a rectangle. Although not shown, the outer edge 82 may take on other geometric or random shapes, may be non-continuous, and/or may contain non-linear, e.g., curved, sections.

The pattern hole-transfer template 70 is preferably made of a material that is sufficiently translucent to permit the user to view an object or medium situated on an opposite side of the template 70. Preferred materials include flexible and rigid plastics, such as polyvinylchloride. It is also possible to use other translucent materials, as well as non-translucent materials, such as metal, alloys, wood, plastic, etc., that are compatible with the objects of this invention.

Discrete circular apertures 80 extend through the substantially flat sheet 72 from the first surface 74 to the second surface 76. As shown in FIG. 4, the apertures 80 are spaced from one another to define discernible patterns. The apertures 80 in the template 70 of FIG. 4 are arranged to define an outline of tangible objects, such as, for example and not necessarily by limitation, a flower, heart, leaf, tree, and star. Straight or curvilinear marking lines may extend between adjacent apertures 80 for accentuating the patterns. Other patterns not shown in the accompanying figures are also contemplated as being within the scope of the present invention.

Methods for forming a pattern of holes in a medium will now be described in greater detail in connection with the aforementioned embodiments. It is understood, however, that the methods of this invention are not necessarily limited to the illustrated embodiments.

The selected embodiment of the pattern hole-transfer template is mounted on a medium. The substantially flat nature of the template facilitates abutment of the first or second surface of the template against the medium. It is not necessary that the template lie continuously flush against the medium, especially if, for example, the template has raised printed markings or the like. Rather, the template sheet is preferably sufficiently flat to allow precise transfer and reproduction of the hole pattern in the medium.

In the context of the currently most preferred embodiment of the invention, the medium in which the pattern of holes is to be formed comprises paper or paper products. Exemplary media include construction paper, greeting cards, vellum, and card stock. The medium may comprise a single layer or multiple layers, e.g., a laminate, of identical or different media. It is also within the scope of the invention to select non-cellulosic materials as the medium. For example, the medium may comprise fabric, decorative foils, clay, ceramics, wood veneer, wood, and the like.

Alignment of the template with the border of the medium during mounting may be facilitated and improved by use of linear markings on the template. For example, the template depicted in FIG. 2 contains marking line pairs 32, 34, 36, 38, and 40. Marking line pairs 32, 34, and 36 are spaced apart from one another by distances of 4.25 inches, 5.5 inches, and 6.25 inches, respectively. These dimensions correspond to lengths and widths of paper media commonly used in the greeting card industry. Marking line pairs 38 and 40 are spaced apart from one another by distances of 8.5 inches and 11 inches, respectively, with correspond to the width and length of standard paper. A selected one of the marking line pairs may be aligned with the edges of a similarly sized medium to ensure that a hole pattern made in the medium is precisely positioned and/or spaced with a uniform border from an edge of the medium. The diagonal marking lines 44 and 46 of FIG. 2 may also be used during mounting. The diagonal marking lines 44 and 46 are set at a 90 degree angle, thus allowing the template 30 to be aligned with the corner of media.

Once mounted, the template may be fixed stationary relative to the medium by the use of mounting pins, tape, or other devices. Alternatively, the user may use his/her hand to hold the template stationary relative to the medium.

The process of this embodiment further comprises repeatedly inserting a tool through the discrete circular apertures of the template and penetrating the tool through the medium to form a pattern of holes in the medium. Suitable tools for penetrating through the medium may include awls, pins, writing utensils, punches, cutting knives, and other devices. Exemplary punches are available from Harbor Freight Tools of Camarillo, Canada. Punches suitable for practicing this method of the invention include tapered punches, spring-loaded punches, hole punches, industrial punches, pin punches, and the like.

In preferred embodiments of the invention, the aperture size may play an important role in ensuring the formation of holes having consistent and uniform size in the medium. Tools for forming holes often have a tapering end that terminates at a sharp point or edge. The tapered tool end facilitates penetration of the tool through the medium and improves the cleanness of the punched hole. However, the size of the hole formed in the medium depends upon the extent to which the tapered portion of the tool is passed through the medium. Stated differently, the farther the tapered tool is passed through the medium, the larger the diameter of the hole formed by the tapered tool. Variations in hole diameter, which is a significant problem with conventional techniques described above, may be avoided by practicing currently preferred embodiments of the invention. The apertures of the template may serve the additional function of acting as a stop means for tools inserted through the discrete circular apertures of the template and into the medium. As the tapered tool is inserted through the discrete circular apertures, the thickness of the tapered tool will eventually match then exceed the diameter of the discrete circular apertures. Once the tool thickness matches the aperture diameter, the edges of the discrete circular apertures will block further forward progress of the tool, thereby regulating the size of the hole formed in the medium. It may be desirable to use more than one tool in carrying out the method of this embodiment, especially where the template includes different sized apertures.

The template then may be removed from the medium. Pins, clips, etc. that may optionally have been used for avoiding movement between the template and medium may be removed. It is optional yet especially preferred to form all of the holes in the medium prior to removal of the template.

Once the template is separated from the medium, the formed medium holes may be decorated or otherwise accentuated. For example, grommets may be mounted about selected or all of the medium holes. The inner diameter of the grommets is preferably identical in size to the hole diameter. Other objects that may be placed around or through the holes include brads, stud-and-post bead works, among others.

According to another preferred embodiment of the invention, the method further comprises stitching thread through holes in the medium. The thread may be stitched according to known stitching patterns. Preferably, the stitching is performed between adjacent medium holes to form lines or outlines to tangible shapes. In the event that grommets are formed around medium holes, the thread may be stitched through the grommets. The thread may comprise a member selected from the group consisting of yarn, filaments, continuous fibers, spun fibers, and wire.

Additional advantages and modifications will readily occur to those skilled in the art. Therefore, the invention in its broader aspects is not limited to the specific details, representative devices and methods, and illustrative examples shown and described. Accordingly, departures may be made from such details without departing from the spirit or scope of the general inventive concept as defined by the appended claims and their equivalents.

What is claimed is:

1. A method for forming a pattern of holes in a medium, said method comprising:
providing a pattern hole-transfer template comprising a substantially flat sheet having a first surface and a second surface opposite and facing away from one another, the substantially flat sheet comprising a plurality of discrete circular apertures spaced apart from one another and extending through the substantially flat sheet from the first surface to the second surface;
mounting the pattern hole-transfer template on a medium;
inserting a tool through the discrete circular apertures of the pattern hole-transfer template and penetrating through the medium to form a pattern of holes in the medium; and
separating the pattern hole-transfer template from the medium.

2. A method as defined in claim 1, wherein the substantially flat sheet is translucent.

3. A method as defined in claim 1, wherein the apertures have identical diameters to one another.

4. A method as defined in claim 1, wherein the apertures comprise a first set of first apertures arranged along a first linear pattern and a second set of second apertures arranged along a second linear pattern, wherein adjacent ones of the first apertures are spaced apart from one another by a first uniform distance, and wherein adjacent ones of the second apertures are spaced apart from one another by a second uniform distance differing from the first uniform distance.

5. A method as defined in claim 4, wherein the first and second linear patterns are parallel to one another.

6. A method as defined in claim 1, wherein the medium has opposite edges, and wherein the substantially flat sheet further comprises markings on the first surface for aligning the template relative to the opposite edges of the medium.

7. A method as defined in claim 6, wherein the pattern comprises a straight aperture line including at least three of the apertures, and wherein the markings comprise first and second marking lines arranged transverse to the straight aperture line, the first and second marking lines being symmetrical to one another and equidistant from a center of the substantially flat sheet.

8. A method as defined in claim 7, wherein the first and second marking lines are spaced apart from one another by a distance of 4.25 inches.

9. A method as defined in claim 7, wherein the first and second marking lines are spaced apart from one another by a distance of 5.5 inches.

10. A method as defined in claim 7, wherein the first and second marking lines are spaced apart from one another by a distance of 6.25 inches.

11. A method as defined in claim 7, wherein the first and second marking lines are spaced apart from one another by a distance of 8.5 inches.

12. A method as defined in claim 7, wherein the first and second marking lines are spaced apart from one another by a distance of 11 inches.

13. A method as defined in claim 7, wherein the substantially flat sheet further comprises a straight marking line arranged transverse to the straight aperture line and centrally located on the substantially flat sheet so as to be equidistant from opposite edges of the substantially flat sheet.

14. A method as defined in claim 1, wherein the apertures comprise a first set of the apertures arranged along a first linear pattern and a second set of the apertures arranged along a second linear pattern transverse to the first linear pattern, the first and second linear patterns each respectively comprising at least three of the apertures, with at least one of the apertures mutually shared by the first and second linear patterns.

15. A method as defined in claim 1, wherein the medium comprises a material comprising cellulosic pulp.

16. A method as defined in claim 1, wherein the medium comprises a member selected from the group consisting of a book and booklet.

17. A method as defined in claim 1, wherein said mounting comprises abutting the medium against a member selected from the group consisting of the first surface and the second surface of the substantially flat sheet.

18. A method as defined in claim 1, wherein the pattern forms an outline of a tangible object.

19. A method as defined in claim 1, further comprising covering the holes with respective grommets.

20. A method as defined in claim 21, wherein the holes each have an aperture of at least 0.47625 cm.

21. A method for forming a pattern of stitch holes in a medium, said method comprising:
providing a stitch pattern hole-transfer template comprising a substantially flat sheet having a first surface and a second surface opposite and facing away from one another, the substantially flat sheet comprising a plurality of discrete circular apertures spaced apart from one another and extending through the substantially flat sheet from the first surface to the second surface;
mounting the stitch pattern hole-transfer template on a medium;
inserting a tool through the discrete circular apertures of the stitch pattern hole-transfer template and penetrating through the medium to form a pattern of stitch holes in the medium;
separating the stitch pattern hole-transfer template from the medium; and
stitching thread through the stitch holes to form a stitch pattern.

22. A method as defined in claim 21, wherein the substantially flat sheet is translucent.

23. A method as defined in claim 21, wherein the apertures have identical diameters to one another.

24. A method as defined in claim 21, wherein the apertures comprise a first set of first apertures arranged along a first linear pattern and a second set of second apertures arranged along a second linear pattern, wherein adjacent ones of the first apertures are spaced apart from one another by a first uniform distance, and wherein adjacent ones of the second apertures are spaced apart from one another by a second uniform distance differing from the first uniform distance.

25. A method as defined in claim 24, wherein the first and second linear patterns are parallel to one another.

26. A method as defined in claim 21, wherein the medium has opposite edges, and wherein the substantially flat sheet further comprises markings on the first surface for aligning the template relative to the opposite edges of the medium.

27. A method as defined in claim 26, wherein the stitch pattern comprises a straight aperture line including at least three of the apertures, and wherein the markings comprise first and second marking lines arranged transverse to the straight aperture line, the first and second marking lines being symmetrical to one another and equidistant from a center of the substantially flat sheet.

28. A method as defined in claim 27, wherein the first and second marking lines are spaced apart from one another by a distance of 4.25 inches.

29. A method as defined in claim 27, wherein the first and second marking lines are spaced apart from one another by a distance of 5.5 inches.

30. A method as defined in claim 27, wherein the first and second marking lines are spaced apart from one another by a distance of 6.25 inches.

31. A method as defined in claim 27, wherein the first and second marking lines are spaced apart from one another by a distance of 8.5 inches.

32. A method as defined in claim 27, wherein the first and second marking lines are spaced apart from one another by a distance of 11 inches.

33. A method as defined in claim 27, wherein the substantially flat sheet further comprises a straight marking line arranged transverse to the straight aperture line and centrally located on the substantially flat sheet so as to be equidistant from opposite edges of the substantially flat sheet.

34. A method as defined in claim 21, wherein the apertures comprise a first set of the apertures arranged along a first linear stitch pattern and a second set of the apertures arranged along a second linear stitch pattern transverse to the first linear stitch pattern, the first and second linear stitch patterns each respectively comprising at least three of the apertures, with at least one of the apertures mutually shared by the first and second linear stitch patterns.

35. A method as defined in claim 21, wherein the medium comprises a material comprising cellulosic pulp.

36. A method as defined in claim 21, wherein the medium comprises a member selected from the group consisting of a book and booklet.

37. A method as defined in claim 21, wherein said mounting comprises abutting the medium against a member selected from the group consisting of the first surface and the second surface of the substantially flat sheet.

38. A method as defined in claim 21, wherein the stitch pattern forms an outline of a tangible object.

39. A method as defined in claim 21, further comprising covering the holes with respective grommets.

40. A method as defined in claim 21, wherein the holes each have an aperture of at least 0.47625 cm.

41. A method as defined in claim 21, wherein the thread comprises a member selected from the group consisting of yarn, filaments, continuous fibers, spun fibers, and wire.

42. A method as defined in claim 21, further comprising covering the stitch holes with respective grommets, wherein said stitching comprises stitching the thread through the stitch holes and the grommets.

43. A method as defined in claim 42, wherein the stitch pattern comprises an outline of a tangible object.

44. A method as defined in claim 42, wherein the stitch holes each have an aperture of at least 0.47625 cm.
